(19) United States
(12) Patent Application Publication
(10) Pub. No.: US 2011/0268273 A1
(43) Pub. Date: Nov. 3, 2011

(54) Data Processing Apparatus for a Field Device

(76) Inventors: Thomas Gros, Neustadt (DE); Ralf Schaetzle, Fischerbach (DE); Fridolin Faist, Oberwolfach (DE)

(21) Appl. No.: 12/913,112

(22) Filed: Oct. 27, 2010

Related U.S. Application Data
(60) Provisional application No. 61/258,734, filed on Nov. 6, 2009.

(30) Foreign Application Priority Data
Nov. 6, 2009 (EP) 09 175 316.0

(51) Int. Cl. H04W 12/00; H04L 9/00

(52) U.S. Cl. 380/270; 380/255

(57) ABSTRACT

A data processing apparatus for a field device of level measurement and/or pressure measurement technology is described. An input is adapted for receiving data from a measurement processing stage and an output is adapted for providing encrypted data. The encrypted data are marked for a recipient of the data as encrypted data.

### REFERENCE TO RELATED APPLICATIONS

This application claims the benefit of the filing date of EP Patent Application Serial No. 0 917 531 6.0 filed Nov. 6, 2009, the disclosure of which is hereby incorporated herein by reference and U.S. Provisional Pat. App. Ser. No. 61/258,734, filed Nov. 6, 2009, the disclosure of which is hereby incorporated by reference.

### TECHNICAL AREA

The present invention relates to the technical area of measurement technique, in particular measurement technique of level and measurement technique of pressure. In particular, the present invention relates to a data processing apparatus, a method for data processing, a data collection apparatus, a method for collecting data and a program element for data processing.

### BACKGROUND OF THE INVENTION

More and more companies are proceeding by putting the operation of their field devices or sensors in the hands of external firms. Costs can be saved by outsourcing the operation of field devices, since no know-how may be provided for the operation of the field devices. The operation of field devices may often do not belong to the core competences of the companies.

However, those responsible for process flows in the industrial plants in the companies always want to be informed of the current measured values that are prevalent in the field, in order to optimise the processes.

A public communication network, such as the internet, may be used to provide the current measured values for many different and often competing firms. A public communication network of this kind may also be called on for distribution of measured values, measurements or measurement values that are supplied by individual field devices. In other words, a public communication network of this kind may also be relied upon for distribution of measured values that are supplied by individual field devices.

Data may be supplied directly from the field devices, or via evaluation devices connected to the field devices, to large databases which run on servers.

Evaluation devices, such as the evaluation devices from the firm VEGA, may transmit measured values in unencrypted form or in uncoded form to a server, such as a VEGA WEB-VV (Visual Vega) server, which may receive the data. The user may then retrieve the measured values from the VEGA WEB-VV Server via Internet with a web browser.

However, during retrieval with the web browser, data may also be transmitted unencrypted over the internet on the way from the field device to the server, i.e. it would perhaps be possible to listen to or alter the data using appropriate means.

The document DE 10 2007 002 351 A1 may describe automatic monitoring and controlling of levels.

The document DE 10 2005 051 580 A1 may describe a communication module for transmission of measured values to a server.

### SUMMARY OF THE INVENTION

It may be regarded as a need for ensuring secure transmission of measured values.

According to an exemplary embodiment of the present invention, a data processing apparatus, a method for data processing, a data collection apparatus, a method for collection of data and a program element for data processing may be created.

According to a further exemplary embodiment of the present invention, a data processing apparatus may be provided for a field device of level measurement, of fill level measurement and/or of pressure measurement technique, which may have an input, an output and an encryption device. The input and the output may each be connected to the encryption device. The input may be adapted to receive data from a measurement processing stage, in particular to receive a measured value. The output may be adapted for providing of data or for providing of the measured value.

Further, the encryption device may be adapted to encrypt or to encode the received data or the received measured value with a predeterminable, adjustable or permanently set up encryption algorithm and the encryption device may be adapted to mark or to identify the encrypted data or the encoded as encrypted data to the recipient of the data or of the measured value. Thus, the data or measured value may be identifiable as being encrypted. In an example, the encryption algorithm may be predeterminable, but if once may be set up, the encryption algorithm may be used permanently. In other words, it may be possible to predetermine the encryption algorithm. Furthermore, the encryption device may be adapted to provide the marked encrypted data at the output of the data processing apparatus. In other words, the encryption device may be adapted to provide the marked and encrypted data at the output of the data processing apparatus. The data processing apparatus may also be referred to as measured value processing apparatus.

The data processing apparatus may be implemented as evaluation device. It can also be integrated in the field device as hardware module or integrated circuit. The field device may be adapted to measure pressures, fill levels and/or levels. In addition, the data processing apparatus may also be used for field devices other than level measurement and pressure measurement technique.

Any form of labelling or marking that, for example, may allow the data collection device or the data collection apparatus to differentiate encrypted data from unencrypted data may be understood as marking of encrypted data. Unencrypted data may be understood as non-encrypted data, i.e. data that may not be encrypted. On the receiver side, for example at the data collection apparatus, reception at locally different inputs may also act as marking, mark or identification, as reception at different physical addresses or at different logical addresses or ports. A MAC (Medium Access Control) address may be a physical address. In particular, a URI (Uniform Resource Identifier) or URL (Uniform Resource Locator) may be an address, in particular if an HTTP protocol (Hypertext Transfer Protocol) or HTTPS protocol (Hypertext Transfer Protocol Secure) may be used for data transmission.

According to another exemplary embodiment of the present invention a method for data processing is provided which may comprise the receiving of data at an input of the data processing apparatus. In an example, the method for data processing may use a data processing apparatus. Furthermore, the method may comprise the encrypting of the received data with a predeterminable encryption algorithm and the marking of the data for a recipient. In other words, the encryption algorithm may be predetermined. This marking or mark may notify the recipient that the data are encrypted, i.e. that encrypted data are present. The marking may also be implemented by sending the data or measured values to different addresses. Following the marking, the providing of the encrypted and marked data may take place at the output of the data processing apparatus.

According to a further exemplary embodiment of the present invention, a data collection apparatus may be created which may have a first input, a second input, a combining device and a decryption device. The inputs may comprise a plurality of inputs. The first input may be connected to the decryption device. The first input may be the input for encrypted data.

The decryption device may be connected to the combining device. Additionally, the second input may be connected to the combining device. Essentially, the unencrypted data may pass via the second input to the combining device.

The decryption device may be adapted to decrypt encrypted data. For the decryption, the decryption device may execute a decryption algorithm, which may be complementary to the encryption algorithm, thus may remove the encryption. Furthermore, the encryption algorithm and the decryption algorithm may use corresponding key pairs, if necessary.

The combining device may be used to combine data which have been received at the first input and data which have been received at the second input. The combining device may provide data at an output in the same format, irrespective of whether the data were previously encrypted or not.

According to a further exemplary embodiment of the present invention, a method may be provided for collecting data which comprises the receiving of data at a first input of a data collection apparatus.

The data received at the first input may be provided to a decryption device or may be forwarded to a decryption device. The decryption device may decrypt the data received at the first input and may provide the decrypted data to a combining device.

The method for collecting data may further comprise receiving of data .at a second input of the data collection device or of the data collection apparatus, for example, and forward the data to the combining device. Thus, the method for collecting data may comprise forwarding the data to the combining device.

The combining device may thus cater for the combining of data from the first input and from the second input. In particular, the combining device may combine, consolidate or merge the previously encrypted data and the unencrypted data in order to treat them uniformly afterwards.

Furthermore, according to an exemplary embodiment of the present invention, a program element for data processing may be provided which, when it may be executed on a processor, may be adapted to execute at least one method selected from the group of methods consisting of the method for data processing according to the invention and the method for collecting of data in accordance with the invention.

According to a still further exemplary embodiment of the present invention, a computer-readable storage medium may be created that comprises a program code which, when it may be executed on a processor, may be set up to execute at least one method selected from the group of methods consisting of the method for data processing in accordance with the invention and the method for collecting of data in accordance with the invention.

A computer-readable storage medium may be a floppy disk or hard disk, a USB storage medium (Universal Serial Bus), a RAM (Random Access Memory), a ROM (Read Only Memory) or an EPROM (Erasable Programmable Read Only Memory). However, a computer-readable storage medium may also be a data network, for example the internet, which allows downloading of a program code.

According to a further exemplary embodiment of the present invention, a data processing apparatus for a field device of the level measurement and/or pressure measurement technology may be provided which may have an input, an output and an encryption device. The input and the output may be connected to the encryption device and the input may be adapted for receiving data from a measurement processing stage. Furthermore, the output may be adapted for providing encrypted data. The encryption device may be adapted to detect whether the received data should be encrypted and if the data should be encrypted, to encrypt the data with an encryption algorithm. It may be possible to predetermine the encryption algorithm. The encryption device may further be adapted to mark the encrypted data for a recipient of the data as encrypted data and to provide the marked and encrypted data at the output.

Further exemplary embodiments and further developments of the invention may result from the dependent patent claims.

I²C, I2C or IIC (for Inter-Integrated Circuit) may be a serial bus for computer systems. It may be used to connect devices with low transmission rate on an embedded system or mainboard.

The HART® protocol (Highway Addressable Remote Transmitter) in particular can be designated as an open master slave protocol for bus-addressable field devices. It can implement a method to transmit data by Frequency Shift Keying (FSK), based on the 4 to 20 mA process signal, in order to facilitate remote configuration and diagnosis checks. In other words, the method may be set on top of or based on the 4 to 20 mA process signal or superimposed on the 4 to 20 mA process signal.

Both I²C and HART® may be suitable as protocol for communication with a field device, e.g. with an evaluation device, with a level measuring device or with a pressure measuring device.

Field devices according to this application may be any type of measuring devices, for example level measuring devices, pressure measuring devices, limit measuring apparatuses, limit value measuring apparatuses or temperature measuring apparatuses, to name only a few examples. Different physical effects may be utilised for acquisition. Measured value acquisition can take place with the aid of radar beams, ultrasound, vibration, guided microwave (TDR, Time Domain Reflexion) or capacitive effects.

A data processing apparatus, for example in an evaluation device or in a field device, may be an apparatus that may transmit both encrypted and unencrypted to a data collection apparatus, such as a server or a database running on a server, over a network. Data may be sent to different destinations or destination addresses, depending on whether the data are encrypted or unencrypted.

Essentially, listening to or alteration of the data may no longer be so simple possible when the data is encrypted. Also monitoring of the data may no longer be so simple possible when the data is encrypted. Thus, by encrypting the data monitoring, listening to or altering of data may be made more difficult.

By using different destination addresses for the encrypted and unencrypted data, existing server applications can be adapted for receiving of encrypted data. Due to the fact that the data collection apparatus or the server can receive unencrypted data in parallel with encrypted data, it may also be possible to use simple field devices that may not have the possibility of encrypting since, for example they essentially may not have the necessary computational power to encrypt the data.

The system may essentially comprise at least one field device or evaluation device, which sends the encrypted data to a server. The server may receive unencrypted data at one destination address and encrypted data at a further destination address. The encrypted data may be decrypted by a module, e.g. the decryption device and may correspond to the format of the unencrypted data after decrypting, so that it may be possible to treat the data uniformly. In other words, this may mean that the further processing of the data may essentially run identically for the previously encrypted data as for the unencrypted data. Thus, also the preparing of the data on the device side may essentially proceed identically in both cases, i.e. in the encrypted case and in the unencrypted case. However, the data may be encrypted before the data is sent, in the case of the encrypted transmission. Essentially the encryption may be reversed immediately following receipt of the encrypted data on the side of the data collection apparatus, in order to process the data further as early as possible, by the usual and thus unencrypted manner.

The provision of encrypted data or of an encrypted measured value to the data collection apparatus by the data processing apparatus may take place event controlled or event based. That is, recognition of the presence of a previously defined situation may trigger an action. An triggering event may be the presence of a measured value in the data processing apparatus. Further, the elapse of a time interval, a measured value exceeding a limit or a limit value or falling below a limit may be regarded as triggering events. Exceeding a threshold or falling below a threshold may also be regarded as a trigger event.

A web client may be implemented in the data processing apparatus which may send the measurement data in an http request to a server. An http request may be characterised by at least one of the keywords or the transmission method POST, HEAD and GET. One of the events within the client may trigger the transmission of the measured data.

According to a further exemplary embodiment of the present invention, at least one item of data may be described as data, which item of data may be selected from the group of data consisting of a measured value, status information and an operating parameter.

Thus unauthorised interrogation or listening of exceedances of measurement values or interrogation of operating parameters by competitors may be made more difficult.

According to a further exemplary embodiment of the present invention, an encryption algorithm or an encrypting algorithm may be used that is selected from the group of encryption algorithms consisting of Advanced Encryption Standard (AES) and Pretty Good Privacy (PGP).

The encryption protocol used may depend on the power of the processor of an evaluation device or of a field device in which it may be implemented.

According to another exemplary embodiment of the present invention, the encryption device may be adapted to recognize whether the data received is to be encrypted and, if the data is to be encrypted, the encryption device may encrypt the data with the specified encryption algorithm.

With this query the data may be encrypted selectively. Data may exist, in particular a type of data may exist, such as parameters for obtaining optimum process results, which may be relevant to security and therefore worthy of protection. Other data may be less relevant to security. Encryption may not be necessary with the latter. A query may be used to recognize whether encryption may be necessary or not.

By doing without encryption for data not relevant to security, it may be possible to save power on the field devices, since no power-intensive encryption method may be employed.

According to a further exemplary embodiment of the present invention the encryption device may be further adapted to detect whether the received data are to be encrypted and if the data are to be encrypted, to encrypt the data with the encryption algorithm. It may be possible to predetermine the encryption algorithm.

According to a further exemplary embodiment of the present invention, the data processing apparatus may have an activation device. The activation device may be connected to the encryption device. The activation device may be adapted to activate the encryption device.

The activation device may be a physical switch, an electronic switch or a software switch. It may be possible to switch complete encoding on or off with the activation device. After encryption has been switched off by the activation device, the data processing apparatus may act like a conventional field device or a conventional evaluation device or evaluation apparatus.

Consequently, the data processing apparatus may not permanently operate with encryption. A user may thus be able to specify when the possibility of encryption should exist, by means of selective encryption of certain data or by means of the activation device. In other words, a user may use the activation device in order to specify when the possibility of encryption or encrypting should exist.

The activation device can also be a smart card reading device. A key may be stored on a smart card, which may be used during encryption. The encryption device may be activated by insertion of the smart card. In an example the smart card may be inserted in the activation device.

According to yet another exemplary embodiment of the present invention, the encryption device may further be adapted to mark the encrypted data with at least one mark, label or identifier which is selected from a group of marks, labels or identifiers. The group of marks may consist of the provision of encrypted data with a destination address for encrypted data, the provision of encrypted data with a destination directory for encrypted data and the provision of encrypted data with a flag for encrypted data.

By using distinguishable or distinct destination addresses and/or distinguishable destination directories, the data processing apparatus may determine where the encrypted and/or where the unencrypted data land on the data collection device. A flag which may be sent with the encrypted data and/or with the non-encrypted data may be evaluated by the data collection apparatus and not by the data processing apparatus.

The non-presence of a label, mark or identifier may also be used as a label, mark or identifier for a particular type of data, such as encrypted data and/or unencrypted data, i.e. non-encrypted data.

According to a still further exemplary embodiment of the present invention, the input to the data processing apparatus may be at least one interface, which is selected from the group of interfaces consisting of a field bus, a field device connector, a field device connection, a field device terminal, a HART® bus, an I²C bus, a Profibus, a Fieldbus Foundation™ bus, a digital input, a 4 . . . 20 mA connector, a 4 . . . 20 mA connection and a 4 . . . 20 mA terminal.

In particular, an evaluation device can have a plurality of inputs of different types. Conventional HART ® field devices can be retrofitted with an encryption function by means of a HART ® input.

The I²C bus may be used for integration of the data processing apparatus on the field device. By integration, it may be possible to retrofit the field device with an encryption function.

According to a still further exemplary embodiment of the present invention, the output of the data processing apparatus may be at least one interface selected from the group of interfaces consisting of a serial interface, an IP (Internet Protocol) interface, an RJ45 interface, a radio interface, a WLAN (Wireless Local Area Network) interface, a GSM (Global System for Mobile communications) interface, a GPRS (General Packet Radio Service) interface, a UMTS (Universal Mobile Telecommunications System) interface, a LTE (Long Term Evolution) interface, a WiMAX (Worldwide Interoperability for Microwave Access) interface, a Bluetooth interface.

It may be possible to connect a data processing apparatus with a data collection apparatus over large distances by means of the different output interfaces of data processing apparatus. The data collection apparatus may have corresponding interfaces.

Thus it may be possible to make a connection via a modem and via the telephone network or via the internet.

According to a further exemplary embodiment of the present invention, a field device or evaluation device may be created which has a data processing apparatus. The field device may be a field device selected from the group of field devices consisting of a level measuring device, a fill level measuring device, a limit measuring device, a limit value measuring device, a limit level measuring device, a temperature measuring device, a pressure measuring device, a flow rate measuring device and a flow measuring device.

According to another exemplary embodiment of the present invention, it may be possible to connect the field device with the data processing apparatus by a screw thread. In other words, it may be possible to attach the field device to the data processing apparatus by a screw thread. Thus, the field device may be connectable with the data processing apparatus by a screw thread. In one example the screw thread may be located on a housing of the field device and on the data processing apparatus, respectively and interlock when screwed together. In another example a bayonet connection may be used instead of the screw thread.

Thus the data processing apparatus may be able to be screwed on to the field device and a field device which still sends data unencrypted may be retrofitted with data encryption. In other words, the data processing apparatus may be screwable to the field device or it may be adapted to be screwed on the field device.

It should be noted that different aspects of the invention have been described with reference to different subject-matters. In particular, some aspects have been described with reference to apparatus type claims, whereas other aspects have been described with reference to method type claims. However, a person skilled in the art can gather from the preceding description and the following description that, except where described otherwise, in addition to each combination of features which belong to a category of subject-matters, any combination between features is also regarded as disclosed by this text that relate to different categories of subject-matters. In particular, combinations between features of apparatus type claims and features of method type claims shall be disclosed.

### BRIEF DESCRIPTION OF THE FIGURES

Further exemplary embodiments of the present invention are described in the following with reference to the figures.

FIG. 1 shows a system for transmission of encrypted measured values in accordance with an exemplary embodiment of the present invention.

FIG. 2 shows a flow diagram of a method for data processing in accordance with an exemplary embodiment of the present invention.

FIG. 3 shows a flow diagram of a method for collecting data in accordance with an exemplary embodiment of the present invention.

### DETAILED DESCRIPTION OF EXEMPLARY EMBODIMENTS

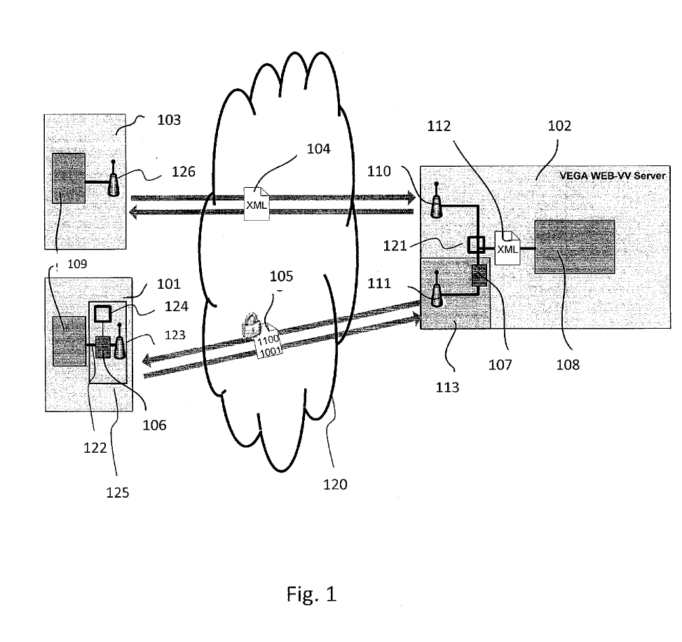

The representation in the figures are schematic and not to scale. In the following description of FIG. 1 to FIG. 3 the same reference numbers are used for the same or corresponding elements.

FIG. 1 shows a system for transmission of encrypted measured values in accordance with an exemplary embodiment of the present invention.

The system comprises the first field device 101 and the second field device 103. The field devices can be examples for data processing apparatuses.

The second field device 103 does not use any encryption or encoding. This second field device 103 can be a conventional field device, for example, in which there is not yet any possibility of encrypted transmission provided. However, this encryption-less field device 103 can also be a field device capable of encrypting, in which encryption is disabled by means of an activation device 124.

The first field device 101 is a field device capable of encrypting, in which encryption is activated by means of an activation device 124.

A measured value processing stage 109 can be a processing stage connected after a sensor (not shown in FIG. 1), which supplies data and in particular a measured value of the sensor. The measurement processing stage 109 provides calibration of the raw data supplied by the sensor, for example.

The second field device 103 transmits the data 104 generated by the measurement processing stage 109 unencrypted via the internet 120 to the second input 110 of a data collection apparatus 102, for example a VEGA WEB-VV server 102. The second input 110 of the data collection apparatus 102 can be addressed via a second destination address. The data 112 are passed to or forwarded to the data processing section 108 or the database 108 of the server 102 and are processed appropriately. The processed data can be interrogated by customers by means of a web browser (not shown in FIG. 1), for example. Data in the data processing section 108 are present in the same uniform format, irrespective of whether the data have been transmitted from field devices 101, 103 to the server 102 encrypted or unencrypted.

As can be seen in FIG. 1, encrypted data and unencrypted data take separate routes through the internet 120.

The first field device 101 encrypts the data generated by the measured value processing stage 109 by means of an encryption method in the encryption device 106 or encrypting device 106. For example, the AES method can be used as encryption method. The encrypted data 105 are sent via the internet 120 or via another communication network 120 to the destination address of the server 102 or the data collection apparatus 102. The destination address may address an input 111 for the encrypted data.

The server 102 decrypts the data by means of the matching decryption process, which is carried out in the decryption device 107. When decryption 107 has been executed, the data 112 are available in the same format as with unencrypted data transmission. In other words, after decryption the data are available in essentially the same format as when unencrypted data are transmitted. The data 112 are forwarded to the data processing section 108 of the WEB-VV server 102 and are processed appropriately. The processed data can be interrogated by customers using a web browser, for example.

Since the distinction whether or not decryption takes place 113 follows from the addressing of an input 110, 111 of the data collection apparatus 102, an unencrypted data transmission, which requires few resources in the second field device 103, can be supplemented by an encrypted data transmission 105. In order to use encryption, the server 102 or the data collection apparatus 102 is supplemented by a decryption device 107, which can be addressed via the first input 111, for example by using a first destination address or a first directory. Encryption can be utilised by the first field device 101, which offers the necessary computational power for carrying out the decryption method in the decryption device 106. Measurement processing stage 109 and data processing stage 108 do not have to be changed in relation to a system that does not provide encryption and can continue to be applied. A system that does not provide encryption thus can be expanded. A hardware module 113 and/or software module 113 can be integrated into an existing data collection apparatus 102 to expand existing data collection apparatuses 102 by the encryption functionality. For this purpose, the expansion module 113 can have an input 111 and an output for connection to a combining device 121 and to a decryption device 107. The hardware module 113 can be implemented as a plug-in card for a server 102 or as an integrated circuit. In another example, the expansion module 113 can have an input 111 and an output for connection to a combining device 121 and to an encryption device 107.

The data processing apparatus 125 can likewise be implemented as a plug-in card or integrated circuit, through which a field device can be expanded by the encryption function.

Selective encryption can be carried out on the data processing apparatus 125. To do this, the data processing apparatus 125 evaluates the data to be transmitted and only encrypts it if encryption is available for the actually queuing data. Thus it is possible to determine before transmission of the data whether encryption is intended for the data to be transmitted or for a corresponding type of data.

Encryption can be essentially completely disabled by means of the activation device 124.

With these groups of components, a field device 101, for example, can be realised which provides permanent encryption and which thus is essentially capable of only sending encrypted data. In another example, however, a field device 101 can be realised that can optionally send unencrypted or encrypted data, as determined by the user or automatically determined on the basis of the type of data, depending on the implementation.

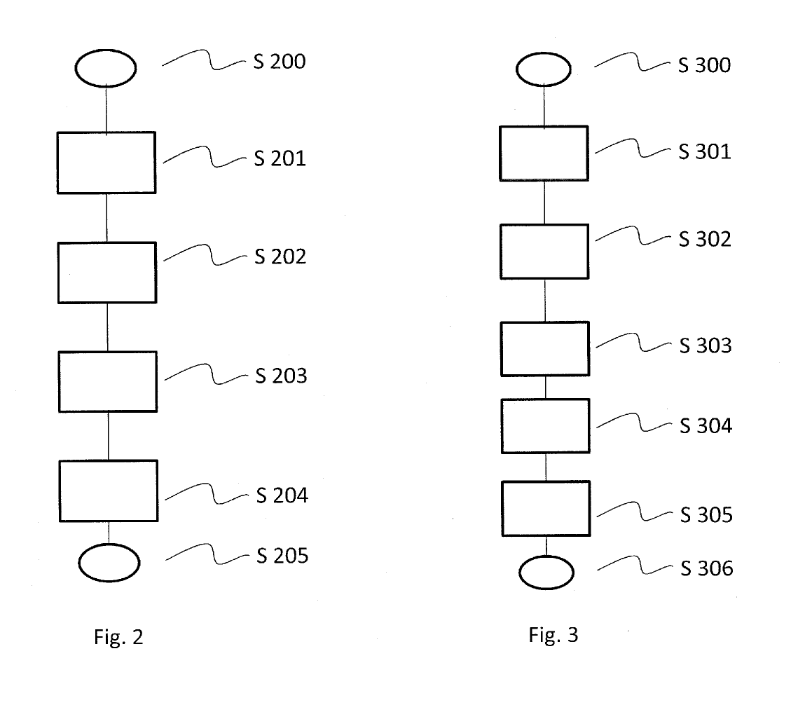

FIG. 2 shows a flow diagram for a method of data processing in accordance with an exemplary embodiment of the present invention.

The process starts in an idle state S200. In step S201, receiving of data takes place at an input of the data processing apparatus.

In step S202, the data received in step S201 are encrypted with an encryption algorithm that can be predetermined and in step S203 the data are marked for a recipient as encrypted data. In other words, the encryption algorithm is predeterminable.

In step S204 provision of the encrypted and marked data takes place at an output of the data processing apparatus 125 before the method reaches the idle state in step S205.

FIG. 3 shows a flow diagram of a method for collecting of data in accordance with an exemplary embodiment of the present invention.

The method starts in the idle state S300. In step S301 receiving of data at a first input of a data collection apparatus 102 takes place.

In step S302 data received at the first input are provided to a decryption device. These data received at the first input are decrypted in step S303 and provided to a combining device 121. In other words, the data received are supplied from the first input to the decryption device, decrypted and then supplied from the decryption device to the combining device 121.

In step S304 receiving of data at a second input of the data collection device takes place and providing the data to the combining device 121 takes place.

In step S305 the data of the first input and the second input are combined, consolidated or merged and transferred to the data processing stage.

In step S306 the process ends in an idle state.

In addition it should be noted that ‘comprising’ and ‘having’ do not exclude any other elements or steps and ‘one’ or ‘a’ does not exclude a plurality. It should further be noted that features or steps that have been described with reference to one of the above embodiments can also be applied in combination with other features or steps of other embodiments described above. Reference numbers in the claims are not to be regarded as limitation.

What is claimed is:

1. A data processing apparatus for a field device of at least one of a level measurement technology and a pressure measurement technology, comprising:
an input arrangement adapted for receiving data from a measurement processing stage;
an output arrangement adapted for providing encrypted data; and
an encryption device connected to the input arrangement and the output arrangement,
wherein the encryption device is adapted to (a) encrypt the received data with a predetermined encryption algorithm, (b) mark the encrypted data for a recipient of the data as encrypted data, (c) provide the marked encrypted data at the output, and (d) mark the encrypted data with at least one mark selected from the group of marks, the group of marks consisting of:
providing the encrypted data with a destination address for encrypted data;
providing the encrypted data with a destination directory for encrypted data; and
providing the encrypted data with a flag for encrypted data.

2. The data processing apparatus of claim 1, wherein the data is at least one item of data, selected from the group of data consisting of a measured value; status information; and an operating parameter.

3. The data processing apparatus of claim 1, wherein the encryption algorithm is selected from the group of encryption algorithms consisting of Advanced Encryption Standard;
and Pretty Good Privacy.

4. The data processing apparatus of claim 1, further comprising:
an activation device connected to the encryption device, the activation device being adapted to activate the encryption device .

5. The data processing apparatus of claim 1, wherein the input arrangement is at least one interface, which is selected from the group of interfaces consisting of a field bus; a field device connector; a HART® bus; an I²C bus; a Profibus; a Fieldbus Foundation™ bus; a digital input; and a 4 . . . 20 mA connector.

6. The data processing apparatus of claim 1, wherein the output arrangement is at least one interface selected from the group of interfaces consisting of a serial interface; an IP interface; an RJ45 interface; a radio interface; a WLAN interface; a GSM interface; a GPRS interface; a UMTS interface; an LTE interface; a WiMAX interface; and a Bluetooth interface.

7. A data processing apparatus for a field device of at least one of a level measurement technology and a pressure measurement technology, comprising:
an input arrangement adapted for receiving data from a measurement processing stage;
an output arrangement adapted for providing encrypted data; and
an encryption device connected to the input arrangement and the output arrangement,
wherein the encryption device is adapted to (a) detect whether the received data are to be encrypted; and if the data are to be encrypted, to encrypt the data with an encryption algorithm that can be predetermined; (b) mark the encrypted data for a recipient of the data as encrypted data; and (c) provide the marked encrypted data at the output arrangement.

8. A field device, comprising:
a data processing apparatus including an input arrangement; an output arrangement; and an encryption device,
wherein the input arrangement and the output arrangement are connected to the encryption device, wherein the input arrangement is adapted for receiving data from a measurement processing stage, wherein the output arrangement is adapted for providing encrypted data, and
wherein the encryption device is adapted to (a) encrypt the received data with an encryption algorithm that can be predetermined; (b) mark the encrypted data for a recipient of the data as encrypted data; (c) provide the marked encrypted data at the output; and (d) mark the encrypted data with at least one mark selected from the group of marks, the group of marks consisting of
providing the encrypted data with a destination address for encrypted data;
providing the encrypted data with a destination directory for encrypted data; and
providing the encrypted data with a flag for encrypted data.

9. The field device of claim 8, wherein the field device is configured to be connected to the data processing apparatus with a screw thread.

10. A field device, comprising:
a data processing apparatus including an input arrangement; an output arrangement; and an encryption device
wherein the input arrangement and the output arrangement are connected to the encryption device; wherein the input arrangement is adapted for receiving data from a measurement processing stage; wherein the output arrangement is adapted for providing encrypted data;
wherein the encryption device is adapted to (a) detect whether the received data are to be encrypted; and if the data are to be encrypted, to encrypt the data with a predetermined encryption algorithm; (b) mark the encrypted data for a recipient of the data as encrypted data; and (c) provide the marked encrypted data at the output arrangement; and
wherein the field device is one of a level measuring device; an evaluation device; a limit measuring device; a temperature measuring device; a pressure measuring device; and a flow measuring device.

11. The field device of claim 10, wherein the field device is configured to be connected to the data processing apparatus with a screw thread.

12. A method for data processing, comprising:
receiving data at an input arrangement of a data processing apparatus;
encrypting of the received data with a predetermined encryption algorithm;
marking the data for a recipient as encrypted data;
providing the encrypted and marked data at an output arrangement of the data processing apparatus; and
marking the encrypted data with at least one mark selected from the group of marks, the group of marks consisting of:
providing the encrypted data with a destination address for encrypted data;
providing the encrypted data with a destination directory for encrypted data; and
providing the encrypted data with a flag for encrypted data.

13. A method for data processing, comprising:
receiving data at an input arrangement of a data processing apparatus;
detecting whether the received data are to be encrypted;
encrypting of the received data with the encryption algorithm that can be predetermined if the data are to be encrypted;
marking the encrypted data for a recipient as encrypted data; and
providing the encrypted and marked data at an output arrangement of the data processing apparatus.

14. A data collection apparatus, comprising:
a first input arrangement;
a second input arrangement;
a combining device connected to the second input arrangement; and
a decryption device connected to the first input arrangement and the combining device;
wherein the decryption device is adapted for decrypting of encrypted data;
wherein the combining device is adapted for combining data received at the first input arrangement and data received at the second input arrangement;
wherein the first input arrangement and the second input arrangement are differentiated with at least one mark selected from the group of marks of received data, the group consisting of a destination address; a destination directory; and a flag.

15. A method for collecting of data, comprising:
receiving data at a first input arrangement of a data collection apparatus;
providing of the data received at the first input arrangement to a decryption device;
decrypting the data received at the first input arrangement and providing the data to a combining device;
receiving data at a second input arrangement of the data collection device and providing the data to the combining device;
combining the data of the first input arrangement and the second input arrangement; and
differentiating the first input arrangement and the second input arrangement with at least one mark selected from the group of marks of received data, the group consisting of a destination address; a destination directory; and a flag.

16. A program element for data processing that, when it is executed on a processor, is adapted to execute at least one method selected from the group of following methods:
(i) a first method comprising:
receiving of data at an input arrangement of a data processing apparatus;
encrypting of the received data with a predetermined encryption algorithm;
marking the data for a recipient as encrypted data;
providing the encrypted and marked data at an output arrangement of the data processing apparatus;
marking the encrypted data with at least one mark selected from the group of marks, the group of marks consisting of:
providing the encrypted data with a destination address for encrypted data;
providing the encrypted data with a destination directory for encrypted data; and
providing the encrypted data with a flag for encrypted data;
(ii) a second method, comprising:
receiving of data at an input arrangement of the data processing apparatus;
detecting whether the received data are to be encrypted;
encrypting of the received data with the predetermined encryption algorithm if the data are to be encrypted;
marking the encrypted data for a recipient as encrypted data; and
providing the encrypted and marked data at an output arrangement of the data processing apparatus; and
(iii) a third method, comprising:
receiving data at a first input arrangement of a data collection apparatus;
providing of the data received at the first input arrangement to a decryption device;
decrypting the data received at the first input arrangement and providing the data to a combining device;
receiving data at a second input arrangement of the data collection device and providing the data to the combining device;
combining the data of the first input arrangement and the second input arrangement; and
differentiating the first input arrangement and the second input arrangement with at least one mark selected from the group of marks of received data, the group consisting of a destination address; a destination directory; and a flag.
